(19) United States
(12) Patent Application Publication
(10) Pub. No.: US 2022/0164050 A1
(43) Pub. Date: May 26, 2022

(54) WINDOW FILM FOR FLEXIBLE DISPLAY

(71) Applicant: DONGWOO FINE-CHEM CO., LTD., Iksan-si, Jeollabuk-do (KR)

(72) Inventors: Geo San LIM, Seoul (KR); Min Kyung KANG, Suwon-si (KR); Seunghee KIM, Yongin-si (KR)

(73) Assignee: DONGWOO FINE-CHEM CO., LTD., Iksan-si, Jeollabuk-do (KR)

(21) Appl. No.: 17/430,827

(22) PCT Filed: Feb. 11, 2020
(86) PCT No.: PCT/KR2020/001895

§ 371 Date: Aug. 13, 2021

(30) Foreign Application Priority Data
Feb. 15, 2019 (KR) 10-2019-0018017

(51) Int. Cl. G06F 3/041; C08J 5/18; G02B 5/30; G09F 9/30; C08K 3/36; C08K 7/26; C08J 7/06; C08J 7/046

(52) U.S. Cl. CPC G06F 3/0412; C08J 5/18; G02B 5/30; G09F 9/301; C08K 3/36; G06F 2203/04103; C08J 7/06; C08J 7/046; G06F 2203/04102; C08J 2379/08; C08K 7/26

(57) ABSTRACT

Provided are a window film for a flexible display. The window film, even if using a polyimide film having high yellowness index, can have a high transmittance as well as low yellowness index by adjusting the color of the entire window film to be neutral. Also disclosed are an optical laminate and a display device containing the optical laminate.

### TECHNICAL FIELD

The present invention relates to a window film for a flexible display, an optical laminate and a display device comprising the same. More particularly, the present invention relates to a window film for a flexible display which, even if using a polyimide film having high yellowness index, can have a high transmittance as well as low yellowness index by adjusting the color of the entire window film to be neutral, an optical laminate and a display device comprising the same.

### BACKGROUND ART

Recently, a display device capable of displaying image-including information has been actively developed. The display device includes a liquid crystal display (LCD) device, an organic light emitting display (OLED) device, a plasma display panel (PDP) device, and a field emission display (FED) device. etc.

In the display device, a window substrate or a window film for protecting the display panel from an external environment may be disposed on a display panel such as an LCD panel and an OLED panel. The window substrate or the window film may include a base substrate made of a glass material, and as a flexible display has been developed recently, a transparent plastic material has been used as the base substrate.

In order to replace conventional window cover glasses for a flexible display, the transparent plastic film should satisfy high hardness and optical properties.

Polyimide (PI) is a high-performance polymer material having high thermal stability, mechanical properties, chemical resistance, and electrical properties, and has been increasingly interested as a substrate material for a flexible display. However, since the polyimide film has a high yellowness index, it should be corrected when applied to a window film requiring transparency.

Korean Patent Application Publication No. 2018-0089860 discloses a polyimide film containing at least one bluing agent to correct the yellowness index of the polyimide film. However, the polyimide film has a problem that the transmittance of the entire film is lowered due to the input of the bluing agent.

### DISCLOSURE OF INVENTION

### Technical Problem

It is an object of the present invention to provide a window film for a flexible display which, even if using a polyimide film having high yellowness index, can have a high transmittance as well as low yellowness index by adjusting the color of the entire window film to be neutral.

It is another object of the present invention to provide an optical laminate comprising the window film for a flexible display.

It is still another object of the present invention to provide a display device having the optical laminate.

### Technical Solution

In accordance with one aspect of the present invention, there is provided a window film for a flexible display, comprising a polyimide film and a low refractive layer on at least one surface of the polyimide film, wherein the low refractive layer has a lower refractive index than that of the polyimide film,

wherein the window film satisfies the following mathematical formulas 1 to 3:

A−B≤0.55(%) [Mathematical Formula 1]

Yellowness Index (YI)≤2.0 [Mathematical Formula 2]

Green Luminous Transmittance (Y)≥92% [Mathematical Formula 3]

wherein,

A is a transmittance (%) at 540 nm, and

B is a transmittance (%) at 480 nm.

In one embodiment of the present invention, a yellowness index (YI) of the polyimide film may exceed 2.0.

In one embodiment of the present invention, a refractive index of the low refractive layer is 1.5 or less, and preferably, may be in a range from the positive square root of a refractive index of the polyimide film−0.1 to the positive square root of a refractive index of the polyimide film+0.2.

In one embodiment of the present invention, a thickness of the low refractive layer may be in a range from 30 nm to 130 nm/(the refractive index of the low refractive layer).

In one embodiment of the present invention, the low refractive layer may be formed from a low refractive layer forming composition comprising a low refractive material, a light-transmitting resin, a photoinitiator and a solvent.

In one embodiment of the present invention, the low refractive material may comprise a hollow silica nanoparticle.

In one embodiment of the present invention, the window film for a flexible display may further comprise a hard coating layer between the polyimide film and the low refractive layer.

In accordance with another aspect of the present invention, there is provided an optical laminate comprising the window film for a flexible display, and an optical layer laminated on one surface of the window film for a flexible display.

In one embodiment of the present invention, the optical layer may comprise at least one of a polarizing plate or a touch sensor.

In accordance with still another aspect of the present invention, there is provided a display device having the optical laminate.

### Advantageous Effects

The window film for a flexible display according to the present invention can have low yellowness index (YI) by adjusting the color of the entire window film to be neutral even if using a polyimide film having yellowness index (YI) exceeding 2.0, and also have a high transmittance due to anti-reflection effects of the low reflective layer.

### DESCRIPTION OF DRAWINGS

FIG. 1 shows transmittance spectra of the window films and polyimide films according to the Examples and Comparative Examples.

### BEST MODE

Hereinafter, the present invention will be described in more detail.

One embodiment of the present invention relates to a window film for a flexible display, comprising a polyimide film and a low refractive layer on at least one surface of the polyimide film, wherein the low refractive layer has a lower refractive index than that of the polyimide film,

wherein the window film satisfies the following mathematical formulas 1 to 3:

A−B≤0.55 (%) [Mathematical Formula 1]

Yellowness Index (YI)≤2.0 [Mathematical Formula 2]

Green Luminous Transmittance (Y)≥92% [Mathematical Formula 3]

wherein,

A is a transmittance (%) 540 nm, and

B is a transmittance (%) at 480 nm.

The yellowness index (YI) is an index indicating the degree of yellowness, which is a value calculated from spectrophotometric data describing the color of a test sample as transparent or white (low YI) to yellow (high YI). Herein, the yellowness index can be measured according to the method described in ASTM E313-73.

The green luminous transmittance (Y) is a value calculated according to CIE 1931 from the measurement of transmittance in a visible light region. Herein, the green luminous transmittance (Y) can be measured with a spectrophotometer, and specifically, may be measured according to the method illustrated in the Experimental Example to be described later.

In one embodiment of the present invention, the destructive interference in the blue region is maximized to improve the blue region transmittance and satisfy the Mathematical Formula I, that is, control the difference (A−B) between the transmittance at 540 nm (A) and the transmittance at 480 nm (B) to be 0.55% or less, so that it is possible to compensate the low blue region transmittance of the polyimide film substrate itself. Accordingly, the window film according to one embodiment of the present invention can have low yellowness index (YI) by adjusting the color of the entire window film to be neutral even if using the polyimide film having yellowness index (YI) exceeding 2.0, and also have a high transmittance due to anti-reflection effects of the low reflective layer.

In one embodiment of the present invention, the difference (A−B) between the transmittance at 540 nm (A) and the transmittance at 480 nm (B), the yellowness index and the green luminous transmittance can be controlled by adjusting the reflective index and thickness of the low reflective layer.

In one embodiment of the present invention, the low reflective layer is a layer having a refractive index lower than that of the polyimide film, and a layer formed so that the reflected light on the surface of the low refractive layer and the reflected light on the interface between the low refractive layer and the polyimide film cause destructive interference with each other.

The refractive index of the low refractive layer may be 1.5 or less so as to cause effective thin film interference, and preferably, may range from the positive square root of a refractive index of the polyimide film −0.1 to the positive square root of a refractive index of the polyimide film +0.2, and more preferably, may range from the positive square root of a refractive index of the polyimide film −0.05 to the positive square root of a refractive index of the polyimide film +0.15. When the refractive index of the low refractive layer is out of the above range, the destructive interference performance may be lowered. Particularly, when the refractive index of the low refractive layer is lower than the above lower limit, the mechanical properties of the low refractive layer may be deteriorated.

In one embodiment of the present invention, the thickness of the low refractive layer may be 30 nm to 130 nm/(the refractive index of the low refractive layer), in order to maximize the destructive interference effect in the blue region. When the thickness of the low refractive layer is less than 30 n, the destructive interference is maximized in UV region, and thus the destructive interference effect in the blue region is slight. When the thickness exceeds 130 nm/(the refractive index of the low refractive layer), the destructive interference is maximized in the region of 600 nm or higher, so that the transmittance in the green or red region may be highly increased. In this case, the yellowness index of the coating film may be greatly increased, so that the film may look yellow.

The window film for a flexible display according to one embodiment of the present invention comprise a polyimide film and a low refractive layer on at least one surface of the polyimide film, wherein the low refractive layer has a lower refractive index than that of the polyimide film.

In one embodiment of the present invention, the polyimide film serves as a base substrate of the window film.

The polyimide film has a yellowness index (YI) exceeding 2.0, and it can be commercially available or can be prepared for use.

The thickness of the polyimide film is not particularly limited, but for example, may be 30 to 100 μm, preferably 40 to 80 μm. When the thickness of the polyimide film is less than 30 μm, the protection performance for the lower layer may be deteriorated and it may be hard to handle it. When the thickness exceeds 100um, the bending properties may be lowered.

In one embodiment of the present invention, the low refractive layer can be formed by applying a low refractive layer forming composition on the polyimide film.

In one embodiment of the present invention, the low refractive layer forming composition may comprise a low refractive material, a light-transmitting resin, a photoinitiator and a solvent.

In one embodiment of the present invention, the low refractive material may have a refractive index of 1.5 or less, and typical examples thereof may include fluorine-containing materials such as MgF₂, hollow nanoparticles such as hollow silica nanoparticles, and silicon-based materials.

The content of the low refractive material is not particularly limited, but may be 1 to 80 parts by weight based on 100 parts by weight of the total low refractive layer forming composition. When the amount of the low refractive material is less than 1 part by weight, the refractive index lowering effect may be slight, and When the amount of the low refractive material exceeds 80 parts by weight, the mechanical properties may be deteriorated.

In one embodiment of the present invention, the light-transmitting resin is a photocurable resin. The photocurable resin may comprise a photocurable (meth)acrylate oligomer and/or monomer.

As the photocurable (meth)acrylate oligomer, epoxy (meth)acrylate, urethane (meth)acrylate, etc. are commonly used, and urethane (meth)acrylate is preferred. The urethane (meth)acrylate can be prepared by reacting a polyfunctional (meth)acrylate having a hydroxyl group in the molecule and a compound having an isocyanate group in the presence of a catalyst. Specific examples of the polyfunctional (meth)acrylate having a hydroxyl group in the molecule may include at least one selected from the group consisting of 2-hydroxyethyl (meth)acrylate, 2-(meth)acrylate, 4-hydroxybutyl (meth)acrylate, caprolactone ring-opened hydroxyacrylate, pentaerythritol tri/tetra(meth)acrylate mixture, and dipentaerythritol penta/hexa(meth)acrylate mixture. Specific examples of the compound having an isocyanate group may include at least one selected from the group consisting of 1,4-diisocyanatobutane, 1,6-diisocyanatohexane, 1,8-thisocyanatooctane, 1,12-diisocyanatododecane, 1,5-diisocyanato-2-methvlpentane, trimethyl-1,6-diisocyanatohexane, 1,3-bis(isocyanatomethyl)cyclohexane, trans-1,4-cyclohexenediisocyanate, 4,4′-methylenebis(cyclohexylisocyanate), isophorone diisocyanate, toluene-2,4-diisocyanate, toluene-2,6-diisocyanate, xylene-1,4-diisocyanate, tetramethylxylene-1,3-diisocyanate, 1-chloromethyl-2,4-diisocyanate, 4,4′-methylenebis(2,6-dimethylphenylisocyanate), 4,4′-oxybis(phenylisocyanate), trifunctional isocyanate derived from hexamethylenediisocyanate and trimethane propanol adduct of toluene diisocyanate.

As the monomer, any monomer commonly used in the art may be used without limitation, but a monomer having an unsaturated group such as a (meth)acryloyl group, a vinyl group, a styryl group, and an allyl group as a photocurable functional group is preferable, and the monomer having a (meth)acryloyl group is more preferable.

Specific examples of the monomer having a (meth)acryloyl group may include at least one selected from the group consisting of neopentyl glycol acrylate, 1,6-hexanediol (meth)acrylate, propylene glycol di(meth)acrylate, triethylene glycol di(meth)acrylate, dipropylene glycol di(meth)acrylate, polyethylene glycol di(meth)acrylate, polypropylene glycol di(meth)acrylate, trimethylolpropane tri(meth)acrylate, trimethylolethane tri(meth)acrylate, 1,2,4-cyclohexane tetra(meth)acrylate, pentaglycerol tri(meth)acrylate, pentaerythritol tetra(meth)acrylate, pentaerythritol tri(meth)acrylate, dipentaerythritol tri(meth)acrylate, dipentaerythritol penta(meth)acrylate, dipentaerythritol tetra(meth)acrylate, dipentaerythritol hexa(meth)acrylate, tripentaerythritol tri(meth)acrylate, tripentaerythritol hexa(meth)acrylate, bis(2-hydroxyethyl)isocyanurate di(meth)acrylate, hydroxyethyl (meth)acrylate, hydroxypropyl (meth)acrylate, hydroxy butyl (meth)acrylate, isooctyl (meth)acrylate, isodecyl (meth)acrylate, stearyl (meth)acrylate, tetrahydrofurfuryl (meth)acrylate, phenoxyethyl (meth)acrylate and isoborneol (meth)acrylate.

The photocurable (meth)acrylate oligomer and monomer exemplified as the light-transmitting resin may be used alone or in combination of two or more.

The light-transmitting resin may be contained, without limitation, in an amount of 1 to 80 parts by weight based on 100 parts by weight of the total low refractive layer forming composition. When the amount is less than 1 part by weight, it is difficult to achieve sufficient hardness improvement, and when it exceeds 80 parts by weight, there is a problem of severe curling.

In one embodiment of the present invention, the photoinitiator may be used without limitation as long as it is used in the art. For example, at least one selected from the group consisting of hydroxyketones, aminoketones, hydrogen abstraction type photoinitiators and combinations thereof may be used.

Specifically, the photoinitiator may include at least one selected from the group consisting of 2-methyl-1-[4-(methylthio)phenyl]2-morpholinepropanone-1, diphenylketone, benzyldimethylketal, 2-hydroxy-2-methyl-1-phenyl-1-one, 4-hydroxycyclophenylketone, dimethoxy-2-phenylacetophenone, anthraquinone, fluorene, triphenylamine, carbazole, 3-methylacetophenone, 4-chloroacetophenone, 4,4-dimethoxyacetophenone, 4,4-diaminobenzophenone, 1-hydroxycyclohexyl phenyl ketone, benzophenone, diphenyl(2,4,6-trimethylbenzoyl)phosphine oxide, and the combination thereof.

The photoinitiator may be contained in an amount of 0.1 to 10 parts by weight, preferably 1 to 5 parts by weight, based on 100 parts by weight of the total low refractive layer forming composition. If the amount of the photoinitiator is less than 0.1 parts by weight, the curing rate of the composition may be low and some parts may be uncured, so that mechanical properties may be deteriorated. If the amount exceeds 10 parts by weight, cracks may occur in a coating film due to overcuring.

In one embodiment of the present invention, the solvent may be used without limitation, as long as it is known in the art as a solvent capable of dissolving or dispersing the above-mentioned composition.

Preferred examples of the solvent may include alcohols (methanol, ethanol, isopropanol, butanol, methyl cellosolve, ethyl cellosolve, etc.), ketones (methyl ethyl ketone, methyl butyl ketone, methyl isobutyl ketone, diethyl ketone, dipropyl ketone, cyclohexanone, etc.), acetates (ethyl acetate, propyl acetate, n-butyl acetate, tertiary butyl acetate, methyl cellosolve acetate, ethyl cellosolve acetate, propylene glycol monomethyl ether acetate, propylene glycol monoethyl ether acetate, propylene glycol monopropyl ether acetate, methoxybutyl acetate, methoxypentyl acetate, etc.), hexanes (hexane, heptane, octane, etc.), benzenes (benzene, toluene, xylene, etc.), ethers (diethylene glycol dimethyl ether, diethylene glycol diethyl ether, diethylene glycol dipropyl ether, diethylene glycol dibutyl ether, propylene glycol monomethyl ether, etc.) and the like. The above exemplified solvents may be used alone or in combination of two or more.

The solvent may be contained in an amount of 10 to 95 parts by weight based on 100 parts by weight of the total low refractive layer forming composition. If the amount of the solvent is less than 10 parts by weight, viscosity may increase to deteriorate workability. If the amount exceeds 9.5 parts by weight, there is a disadvantage that drying process may take a long time and the economical efficiency max be lowered.

In one embodiment of the present invention, in addition to the above components, the low refractive layer forming composition may further comprise other components commonly used in the art, such as antioxidants, UV absorbers, light stabilizers, thermal polymerization inhibitors, leveling agents, surfactants, lubricants, antifouling agents, etc.

The low refractive layer may be formed by applying the low refractive layer forming composition on one surface or both surfaces of the polyimide film, followed by drying and UV curing.

The coating process of the low refractive layer forming composition can be carried out by suitably using a known method such as die coater, air knife, reverse roll, spray, blade, casting, gravure, micro gravure, and spin coating.

After the low refractive layer forming composition is coated on the polyimide film, a drying process may be carried out by evaporating volatiles at a temperature of 30 to 150° C. for 10 seconds to 1 hour, more specifically 30 seconds to 30 minutes, and then, a curing process can be performed by UV radiation. Particularly, the irradiation amount of UV ray may be about 0.01 to 10 J/cm², more particularly 0.1 to 2 J/cm².

The window film according to one embodiment of the present invention may further comprise a hard coating layer between the polyimide film and the low refractive layer to improve mechanical strength.

In the case that the hard coating layer is further comprised, the window film may be laminated in the order of the polyimide film/hard coating layer/low refractive layer.

In addition, a hard coating layer and/or low refractive layer may be further laminated on the back surface of the polyimide film. In this case, the window film may be laminated in the order of the hard coating layer/polyimide film/hard coating layer/low refractive layer, or low refractive layer/hard coating layer/polyimide film/hard coating layer/low refractive layer.

The hard coating layer may have additional antistatic properties and the like.

One embodiment of the present invention relates to an optical laminate comprising the window film for a flexible display, and an optical layer laminated on one surface of the window film for a flexible display.

The optical layer may comprise at least one of a polarizing plate and a touch sensor.

In one embodiment of the present invention, the polarizing plate may include a polarizer and, if necessary, a protective film laminated on at least one surface of the polarizer.

In addition, the touch sensor may be a touch sensor in which a separation layer is formed on a carrier substrate to perform a touch sensor forming process, and when separated from the carrier substrate, the separation layer is used as a wiring covering layer. For example, the touch sensor may be a film touch sensor having a film shape.

One embodiment of the present invention relates to a display device having the above-described optical laminate.

The display device according to one embodiment of the present invention has the optical laminate attached onto one surface of a display panel.

The type of the display device is not particularly limited, but examples thereof may include a liquid crystal display device, an organic EL display device, a plasma display device, a field emission display device, a cathode ray tube display device, etc.

The display panel is not particularly limited, and may have elements commonly used in the art. In addition, it may further include other elements commonly used in the art.

Hereinafter, the present invention will be described in more detail with reference to examples, comparative examples and experimental examples. It should be apparent to those skills in the art that these examples, comparative examples and experimental examples are for illustrative purpose only, and the scope of the present invention is not limited thereto.

### PREPARATION EXAMPLE 1

### Preparation of Low Refractive Layer Forming Composition

2 parts by weight of dipentaerythritol hexaacrylate, 6 parts by weight of hollow silica (JGC C&C, THRULYA4320, solid content 20%), 0.5 parts by weight of a photoinitiator (BASF, Irgacure 184), 91.2 parts by weight of propylene glycol, and 0.3 parts by weight of a leveling agent (BYK, BYK-UV3570) were mixed to prepare a low refractive layer forming composition.

The refractive index after curing of the low refractive layer forming composition was 1.35.

### EXAMPLES 1 TO 3 AND COMPARATIVE EXAMPLES 1 TO 3

### Preparation of Window Film

The low refractive layer forming composition obtained in Preparation Example 1 was coated on a 40 μm transparent polyimide film (Sumitomo Chemical Co., Ltd., YI 2.33, refractive index: 1.54) using each meyer bar coater listed in Table 1 below, followed by drying at 90° C. for 3 minutes. Then, under a nitrogen purge, irradiation with 600 mJ/cm² of UV was carried out using a high-pressure mercury lamp to form a low refractive layer having each dry thickness shown in Table 1 below to prepare a window film.

TABLE 1

| | Meyer Bar # | Dry Thickness (nm) |
|---|---|---|
| Example 1 | 4 | 70 |
| Example 2 | 5 | 80 |
| Example 3 | 3 | 60 |
| Comparative Example 1 | 7 | 110 |
| Comparative Example 2 | 6 | 100 |
| Comparative Example 3 | 8 | 125 |

### EXPERIMENTAL EXAMPLE 1

The physical properties of the above prepared window films were measured as follows, and the results are shown in Table 2 below.

1) Transmittance Spectrum

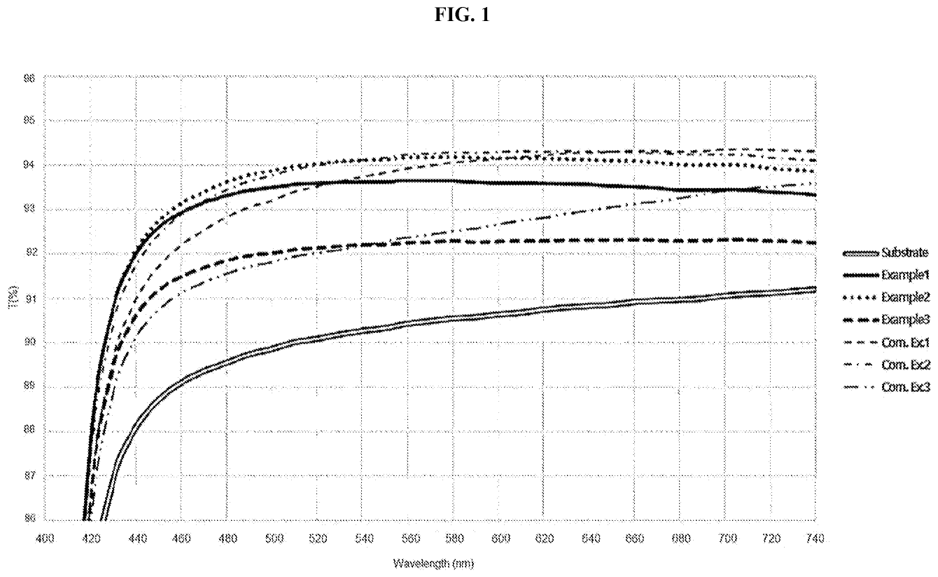

The transmittance spectrum of the prepared window film was measured using a Konica Minolta integrating sphere spectrophotometer (CM-3600d) in SCI mode. The results are shown in FIG. 1. The difference (A−B) between transmittance at 540 nm (A) and transmittance at 480 nm (B) was calculated.

2) Yellowness Index (YI)

The yellowness index of the prepared window film was measured using a Konica Minolta integrating sphere spectrophotometer (CM-3600d) in SCI mode with the ASTM E313-73 standard method.

3) Green Luminous Transmittance (Y)

The green luminous transmittance (Y) of the prepared window film was measured using a Konica Minolta integrating sphere spectrophotometer (CM-3600d) in SCI mode.

TABLE 2

| | A | B | | Green | Yellow- |
|---|---|---|---|---|---|
| | (Trans- | (Trans- | | Luminous | ness |
| | mittance | mittance | | Trans- | Index |
| | at 540 nm) | at 480 mn) | A − B | mittance (Y) | (YI) |
| Example 1 | 93.62% | 93.31% | 0.31% | 93.57% | 1.63 |
| Example 2 | 94.11% | 93.62% | 0.49% | 94.07% | 1.98 |
| Example 3 | 92.19% | 91.84% | 0.35% | 92.18% | 1.68 |
| Comparative | 93.74% | 92.83% | 0.91% | 93.78% | 2.74 |
| Example 1 | | | | | |
| Comparative | 94.12% | 93.44% | 0.68% | 94.11% | 2.32 |
| Example 2 | | | | | |
| Comparative | 97.18% | 91.55% | 0.63% | 92.29% | 7.26 |
| Example 3 | | | | | |
| Uncoated | 90.27% | 89.55% | 0.72% | 90.33% | 2.33 |
| Substrate | | | | | |

As can be seen from Table 2, the window films of Examples 1 to 3 having a difference (A−B) between the transmittance at 540 nm (A) and the transmittance at 480 nm (B) adjusted to 0.55% or less showed increased transmittance in the blue region to have a low yellowness index (YI) of 2.0 or less. Further, it was confirmed that, compared with the polyimide film which is not coated with the low refractive layer forming composition, they had increased green luminous transmittance (Y) of 92% or more.

On the other hand, in the cases of the window films of Comparative Examples 1 to 3 in which a difference (A−B) between the transmittance at 540 nm (A) and the transmittance at 480 nm (B) exceeds 0.55%, and the polyimide film which is not coated with the low refractive layer forming composition, a sharp slope appeared in the blue region, resulting in high yellowness index (YI) exceeding 2.0.

Although specific parts of the present invention have been described in detail, it will be apparent to those skilled in the art that these specific descriptions are merely a preferred embodiment and that the scope of the present invention is not limited thereto. In addition, those skilled in the art will appreciate that various applications and modifications can be made without departing from the scope of the invention based on the descriptions above.

Therefore, the substantial scope of the present invention is to be defined by the appended claims and equivalents thereof.

1. A window film for a flexible display, comprising a polyimide film and a low refractive layer on at least one surface of the polyimide film, wherein the low refractive layer has a lower refractive index than that of the polyimide film,
wherein the window film satisfies the following mathematical formulas 1 to 3:
A−B≤0.55 (%) [Mathematical Formula 1]
Yellowness Index (YI)≤2.0 [Mathematical Formula 2]
Green Luminous Transmittance (Y)≥92% [Mathematical Formula 3]
wherein,
A is a transmittance (%) at 540 nm, and
B is a transmittance (%) at 480 nm.

2. The window film for a flexible display of claim 1, wherein a yellowness index (YI) of the polyimide film exceeds 2.0.

3. The window film for a flexible display of claim 1, wherein a refractive index of the low refractive layer is 1.5 or less.

4. The window film for a flexible display of claim 3, wherein the refractive index of the low refractive layer is in a range from the positive square root of a refractive index of the polyimide film −0.1 to the positive square root of a refractive index of the polyimide film +0.2.

5. The window film for a flexible display of claim 1, wherein a thickness of the low refractive layer is in a range from 30 nm to 130 nm/(the refractive index of the low refractive layer).

6. The window film for a flexible display of claim 1, wherein the low refractive layer is formed from a low refractive layer forming composition comprising a low refractive material, a light-transmitting resin, a photoinitiator and a solvent.

7. The window film for a flexible display of claim 6, wherein the low refractive material comprises a hollow silica nanoparticle.

8. The window film for a flexible display of claim 1, further comprising a hard coating layer between the polyimide film and the low refractive layer.

9. An optical laminate comprising the window film for a flexible display of claim 1, and an optical layer laminated on one surface of the window film for a flexible display.

10. The optical laminate of claim 9, wherein the optical layer comprises at least one of a polarizing plate or a touch sensor.

11. A display device having the optical laminate of claim 9.

12. An optical laminate comprising the window film for a flexible display of claim 2, and an optical layer laminated on one surface of the window film for a flexible display.

13. An optical laminate comprising the window film for a flexible display of claim 3, and an optical layer laminated on one surface of the window film for a flexible display.

14. An optical laminate comprising the window film for a flexible display of claim 4, and an optical layer laminated on one surface of the window film for a flexible display.

15. An optical laminate comprising the window film for a flexible display of claim 5, and an optical layer laminated on one surface of the window film for a flexible display.

16. An optical laminate comprising the window film for a flexible display of claim 6, and an optical layer laminated on one surface of the window film for a flexible display.

17. An optical laminate comprising the window film for a flexible display of claim 7, and an optical layer laminated on one surface of the window film for a flexible display.

18. An optical laminate comprising the window film for a flexible display of claim 8, and an optical layer laminated on one surface of the window film for a flexible display.
